(19) United States
(12) Patent Application Publication
(10) Pub. No.: US 2023/0146385 A1
(43) Pub. Date: May 11, 2023

(54) BATTERY AND IMPLANTABLE MEDICAL DEVICE INCLUDING SAME

(71) Applicant: Medtronic, Inc., Minneapolis, MN (US)

(72) Inventors: Joseph J. Viavattine, Vadnais Heights, MN (US); Brad C. Tischendorf, Minneapolis, MN (US)

(21) Appl. No.: 17/523,571

(22) Filed: Nov. 10, 2021

(51) Int. Cl. H01M 50/593; H01M 4/66; H01M 50/531

(52) U.S. Cl. CPC H01M 50/593; H01M 4/661; H01M 50/531; H01M 2004/021

(57) ABSTRACT

Various embodiments of a battery and an implantable medical device that includes such battery are disclosed. The battery includes a cathode and an anode. The cathode includes a current collector, active material disposed on the current collector, and a cathode tab that extends from the current collector. A cathode spacer is electrically connected to the cathode tab. Further, the anode includes a current collector, active material disposed on the current collector, and an anode tab extending from the current collector. An anode spacer is electrically connected to the anode tab. At least one of the cathode spacer or the anode spacer includes niobium.

### TECHNICAL FIELD

This disclosure generally relates to batteries and, more particularly, to batteries utilized with implantable medical devices.

### BACKGROUND

Medical devices such as implantable medical devices (IMDs) include a variety of devices that deliver therapy (such as electrical stimulation or drugs) to a patient, monitor a physiological parameter of a patient, or both. IMDs typically include one or more functional components encased in a housing. The housing is implanted in a body of the patient. For example, the housing can be implanted in a pocket created in a torso of a patient. The housing can include various internal components such as batteries and capacitors to deliver energy for therapy delivered to a patient and/or to power circuitry for monitoring a physiological parameter of a patient and controlling the functionality of the medical device.

In general, a battery can include one or more positive electrodes or cathodes, one or more negative electrodes or anodes, and an electrolyte provided within a case or housing. Separators made from a porous polymer or other suitable material can also be provided intermediate or between the positive and negative electrodes to prevent direct contact between adjacent electrodes. One or more of the electrodes can include a current collector having an active material provided thereon.

### SUMMARY

In general, the present disclosure provides various embodiments of a battery and an implantable medical device that includes such battery. The battery can include one or more cathodes and one or more anodes. One or more of the cathodes can include a current collector and active material disposed on the current collector. A cathode spacer can be electrically connected to a cathode tab that extends from the cathode current collector. Such cathode spacer can be utilized to electrically connect the cathode to a cathode tab of another cathode of the battery. Similarly, one or more anodes can include a current collector and active material disposed on the current collector. An anode spacer can be electrically connected to an anode tab that extends from the anode current collector. The anode spacer can be utilized to electrically connect the anode to an anode tab of another anode of the battery.

This disclosure includes without limitation the following clauses:

Clause 1: In one example, aspects of this disclosure relate to a battery that includes a cathode and an anode. The cathode includes a current collector, active material disposed on the current collector, and a cathode tab that extends from the current collector. A cathode spacer that includes niobium is electrically connected to the cathode tab. Further, the anode includes a current collector, active material disposed on the current collector, and an anode tab extending from the current collector. An anode spacer that includes niobium is electrically connected to the anode tab.

Clause 2: The battery of clause 1, further including a separator disposed between the cathode and the anode.

Clause 3: The battery of any one of clauses 1-2, where the active material of at least one of the cathode or the anode includes lithium.

Clause 4: The battery of any one of clauses 1-3, where the current collector of the cathode includes a thickness in a range of about 8 μm to about 127 μm.

Clause 5: The battery of any one of clauses 1-3, where the current collector of the cathode includes a thickness in a range of about 25 μm to about 75 μm.

Clause 6: The battery of any one of clauses 1-5, where the current collector of the anode includes a thickness in a range of about 8 μm to about 127 μm.

Clause 7: The battery of any one of clauses 1-5, where the current collector of the anode has a thickness in a range of about 25 μm to about 75 μm.

Clause 8: The battery of any one of clauses 1-7, where the battery is a stacked plate battery.

Clause 9: The battery of any one of clauses 1-8, where the current collector of the anode includes copper.

Clause 10: The battery of any one of clauses 1-8, where the current collector of at least one of the anode or the cathode includes titanium.

Clause 11: The battery of any one of clauses 1-10, where the cathode includes a thickness in a range of about 2.54 mm to about 12.7 mm.

Clause 12: The battery of any one of clauses 1-11, where the cathode spacer includes a thickness in a range of about 0.127 mm to about 5.08 mm.

Clause 13: The battery of any one of clauses 1-12, where the anode includes a thickness in a range of about 2.54 mm to about 12.7 mm.

Clause 14: The battery of any one of clauses 1-13, where the anode spacer includes a thickness in a range of about 0.127 mm to about 5.08 mm.

Clause 15: The battery of any one of clauses 1-14, where the niobium of at least one of the cathode spacer or the anode spacer includes a niobium alloy including titanium.

Clause 16: An implantable medical device including the battery of any one of clauses 1-15.

Clause 17: In another example, aspects of this disclosure relate to a battery that includes an electrode stack having a plurality of electrodes, where each electrode of the plurality of electrodes is either an anode or a cathode. Each electrode includes a current collector that includes copper or titanium. The plurality of electrodes includes a first electrode and a second electrode. The first electrode includes a first tab extending from the current collector of the first electrode, and the second electrode includes a second tab extending from the current collector of the second electrode. The battery further includes a spacer disposed between the first tab and the second tab and electrically connected to the first and second tabs, where the spacer includes niobium.

Clause 18: The battery of clause 17, where the spacer includes a first spacer, where the plurality of electrodes includes a third electrode including a third tab extending from the current collector of the third electrode, where the second tab is disposed between the first tab and the third tab, the battery further including a second spacer disposed between the second tab and the third tab, the second spacer including niobium.

Clause 19: The battery of clause 17, where the first electrode includes a first anode and the second electrode includes a second anode, where the first tab includes a first anode tab and the second tab includes a second anode tab, where the plurality of electrodes further includes a first cathode including a first cathode tab extending from the current collector of the first cathode and a second cathode including a second cathode tab extending from the current collector of the second cathode, where the first cathode tab and the second cathode tab are stacked adjacent to the first anode tab and the second anode tab.

Clause 20: The battery of clause 19, where the spacer includes an anode spacer disposed between the first anode tab and the second anode tab, where the battery further includes a cathode spacer disposed between the first cathode tab and the second cathode tab.

Clause 21: The battery of any one of clauses 19-20, where the current collector of each of the first and second anodes includes copper.

Clause 22: The battery of any one of clauses 19-21, where the current collector of each of the first and second cathodes including titanium.

Clause 23: The battery of any one of clauses 17-22, where the current collector of at least one electrode of the plurality of electrodes includes a thickness in a range of about 25 μm to about 75 μm.

Clause 24: The battery of any one of clauses 17-23, where the niobium of the spacer includes niobium alloys.

Clause 25: The battery of any one of clauses 17-24, further including active material disposed on the current collector of each of the first and second electrodes.

Clause 26: The battery of clause 25, where the active material includes at least one of lithium or carbon.

Clause 27: The battery of any one of clauses 17-26, further including a separator disposed between the first electrode and the second electrode.

Clause 28: The battery of any one of clauses 17-27, where at least one of the first electrode or second electrode includes a thickness in a range of about 2.54 mm to about 12.7 mm.

Clause 29: The battery of any one of clauses 17-28, where the spacer includes a thickness in a range of about 0.127 mm to about 5.08 mm.

Clause 30: An implantable medical device including the battery of any one of clauses 17-29.

Clause 31: In another example, aspects of this disclosure relate to a method for forming a battery. The method includes providing a cathode that includes a current collector, a cathode tab extending from the current collector, and an active material disposed on the current collector; and disposing a cathode spacer in contact with the cathode tab such that the cathode spacer is electrically connected to the cathode, where the cathode spacer includes niobium. The method further includes providing an anode that includes a current collector, an anode tab extending from the current collector, and active material disposed on the current collector; and disposing an anode spacer in contact with the anode tab such that the anode spacer is electrically connected to the anode, where at least one of the cathode spacer or the anode spacer includes niobium.

Clause 32: The method of clause 31, further including disposing a separator between the cathode and the anode.

Clause 33: The method of any one of clauses 31-32, further including disposing a second cathode adjacent to the anode such that the anode is disposed between the cathode and the second cathode, where the second cathode includes a second current collector, a second cathode tab extending from the second current collector, and an active material disposed on the current collector.

Clause 34: The method of clause 33, further including electrically connecting the cathode to the second cathode utilizing the cathode spacer.

Clause 35: The method of clause 34, further including disposing a second anode adjacent to the second cathode such that the second cathode is disposed between the anode and the second anode, where the second anode includes a second current collector, a second anode tab extending from the second current collector, and active material disposed on the second current collector.

Clause 36: The method of claim 35, further including electrically connecting the anode to the second anode utilizing the anode spacer.

Clause 37: The method of claim 36, further including disposing a separator between the anode and the second cathode and a separator between the second cathode and the second anode.

Clause 38: The method of claim 31, further including disposing the cathode, anode, cathode spacer, and second spacer in a housing.

Clause 39: The method of any one of clauses 31-38, where the current collector of at least one of the cathode or the anode includes titanium.

Clause 40: The method of any one of clauses 31-38, where the current collector of at least one of the cathode or the anode includes copper.

Clause 41: The method of any one of clauses 31-40, where each of the cathode spacer and the anode spacer comprises niobium.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

In this application, terms such as “a,” “an,” and “the” are not intended to refer to only a singular entity but include the general class of which a specific example can be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a schematic view of one embodiment of a medical device system that includes an implantable medical device.

FIG. 2 is a schematic partial exploded view of the implantable medical device of FIG. 1.

FIG. 3 is a schematic perspective view of a portion of one embodiment of a battery that can be utilized with the implantable medical device of FIG. 2.

FIG. 4 is a schematic plan view of a portion of the battery of FIG. 3.

FIG. 5 is a schematic cross-section view of a portion of the battery of FIG. 3.

FIG. 6 is a flowchart of one embodiment of a method for forming the battery of FIG. 3.

### DETAILED DESCRIPTION

In general, the present disclosure provides various embodiments of a battery and an implantable medical device that includes such battery. The battery can include one or more cathodes and one or more anodes. One or more of the cathodes can include a current collector and active material disposed on the current collector. A cathode spacer can be electrically connected to a cathode tab that extends from the cathode current collector. Such cathode spacer can be utilized to electrically connect the cathode to a cathode tab of another cathode of the battery. Similarly, one or more anodes can include a current collector and active material disposed on the current collector. An anode spacer can be electrically connected to an anode tab that extends from the anode current collector. The anode spacer can be utilized to electrically connect the anode to an anode tab of another anode of the battery.

In one or more embodiments, the anode collector can include copper. Such copper anode current collectors for stacked plate batteries can enable thinner collectors to be used while improving and/or reducing cell resistance and interconnect heating. Copper has a favorable phase diagram with niobium that can be utilized for the anode spacer. According to various implementations, niobium spacers are used with copper anode current collectors. Niobium spacers can additionally or alternatively be used with titanium cathode collectors. Using the same spacer material for both the anode and the cathode current collectors can assist in the manufacturing process. Having a titanium spacer mistakenly placed with the copper anode current collector can result in a non-ideal laser weld joint because there are several intermetallic species in a copper/titanium system.

According to embodiments described herein, a reduction in thickness of the anode current collectors, which is enabled by the use of copper for such collectors, can result in about a 10% increase in battery capacity as the volume that would have been occupied by thicker collectors can instead be filled with active material. The copper current collector can promote better adhesion to the active material (e.g., lithium). It also has the potential to eliminate environmentally assisted cracking (EAC). EAC is a failure mechanism that allows for a crack to initiate and grow in the weld from residual stress that is assisted by the electrochemical conditions of the battery at the anode interconnect.

A variety of medical devices can utilize one or more batteries as a power source for operational power. For example, an implantable medical device (IMD) such as one that provides cardiac rhythm management therapy to a patient can include a battery to supply power for the generation of electrical therapy or other functions of the IMD. For ease of illustration, examples of the present disclosure will be described primarily regarding batteries employed in IMDs that provide cardiac rhythm management therapy. However, as will be apparent from the description herein, examples of the disclosure are not limited to IMDs that provided such therapy. For example, in some instances, one or more of the example batteries describe herein can be used by a medical device configured to deliver electrical stimulation to a patient in the form of neurostimulation therapy (e.g., spinal cord stimulation therapy, deep brain stimulation therapy, peripheral nerve stimulation therapy, peripheral nerve field stimulation therapy, pelvic floor stimulation therapy, and the like). In one or more embodiments, exemplary batteries of this disclosure can be utilized in medical devices configured to monitor one or more patient physiological parameters, e.g., by monitoring electrical signals of the patient, alone or in conjunction with the delivery of therapy to the patient.

In one or more embodiments, a battery of an IMD can include a plurality of electrodes or electrode plates (e.g., including both anodes and cathodes) stacked on each other in which each of the electrodes includes a tab extending therefrom. The tabs of the anodes can be aligned with each other in a stack and electrically connected to each other to form an anode of the battery. In this sense, the tab stack can function as an electrical interconnect between the anodes. Similarly, the tabs of the cathodes can be aligned with each other in a stack and electrically connected to each other to form a cathode of the battery. In one or more embodiments, such a battery can be referred to as a stacked plate battery.

In one or more embodiments, in each of the anode tab stack and the cathode tab stack, a spacer can be located between adjacent individual tabs in the stack of tabs, e.g., such that each individual tab is separated from an adjacent tab by a spacer. The spacers can be electrically conductive to electrically connect the respective tabs in the stack to each other and define an electrical interconnect, at least in part, between respective electrodes. For each electrode, the tabs in the stack of tabs and spacers can be attached to each other by one or more side laser welds that span the height of the tab stack.

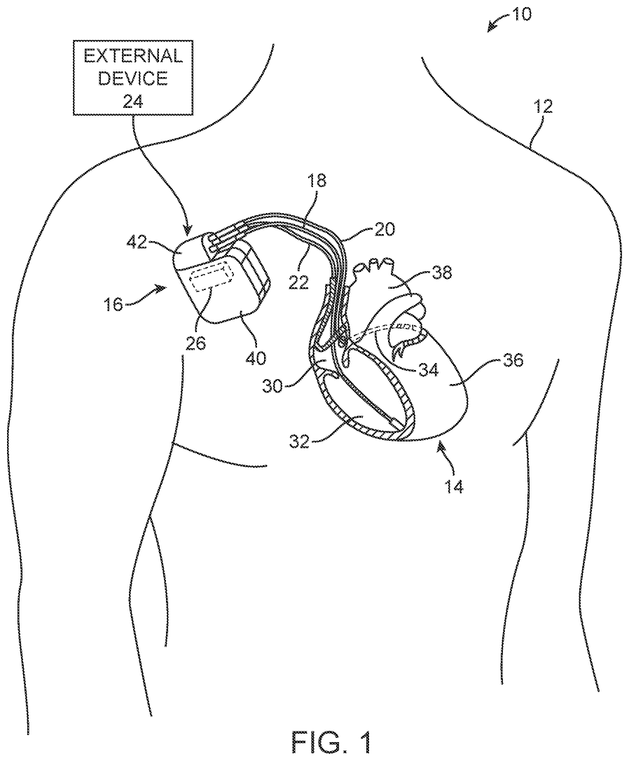

FIG. 1 is a schematic view of one embodiment of a medical device system 10 that can be utilized to deliver therapy to a patient 12. The system 10 includes IMD 16 that is connected (or “coupled”) to leads 18, 20, and 22. IMD 16 can be, for example, a device that provides cardiac rhythm management therapy to heart 14, and can include, for example, an implantable pacemaker, cardioverter, and/or defibrillator that provides therapy to a heart 14 of the patient 12 via electrodes coupled to one or more of leads 18, 20, and 22. In one or more embodiments, IMD 16 can deliver pacing pulses, but not cardioversion or defibrillation shocks, while in other examples, IMD 16 can deliver cardioversion or defibrillation shocks, but not pacing pulses. In one or more embodiments, IMD 16 can deliver pacing pulses, cardioversion shocks, and defibrillation shocks.

IMD 16 can include electronics and other internal components necessary or desirable for executing the functions associated with the device. In one or more embodiments, IMD 16 includes one or more of processing circuitry, memory, signal generation circuitry, sensing circuitry, telemetry circuitry, and a power source. In general, memory of IMD 16 can include computer-readable instructions that, when executed by a processor of the IMD, cause it to perform various functions attributed to the device herein. For example, processing circuitry of IMD 16 can control the signal generator and sensing circuitry according to instructions and/or data stored on memory to deliver therapy to patient 12 and perform other functions related to treating condition(s) of the patient.

IMD 16 can include or can be one or more processors or processing circuitry, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” and “processing circuitry” as used herein can refer to any of the foregoing structure or any other structure suitable for implementation of the techniques described herein.

Memory can include any volatile or non-volatile media, such as a random-access memory (RAM), read only memory (ROM), non-volatile RAM (NVRAM), electrically erasable programmable ROM (EEPROM), flash memory, and the like. Memory can be a storage device or other non-transitory medium.

The signal generation circuitry of IMD 16 can generate electrical therapy signals that are delivered to the patient 12 via electrode(s) on one or more of leads 18, 20, and 22, to provide pacing signals or cardioversion/defibrillation shocks, as examples. The sensing circuitry of IMD 16 can monitor electrical signals from electrode(s) on leads 18, 20, and 22 to monitor electrical activity of heart 14. In one or more embodiments, the sensing circuitry can include switching circuitry to select which of the available electrodes on leads 18, 20, and 22 of IMD 16 are used to sense the heart activity. Additionally, the sensing circuitry of IMD 16 can include multiple detection channels, each of which includes an amplifier, as well as an analog-to-digital converter for digitizing the signal received from a sensing channel (e.g., electrogram signal processing by processing circuitry of the IMD).

Telemetry circuitry of IMD 16 can be used to communicate with another device, such as external device 24. Under the control of the processing circuitry of IMD 16, the telemetry circuitry can receive downlink telemetry from and send uplink telemetry to external device 24 with the aid of an antenna, which can be internal and/or external.

The various components of IMD 16 can be coupled to a power source such as battery 26. Battery 26 can be a lithium primary battery or lithium secondary (rechargeable) battery although other types of battery chemistries are contemplated. Battery 26 can be capable of holding a charge for several years. In general, battery 26 can supply power to one or more electrical components of IMD 16, such as, e.g., the signal generation circuitry, to allow the device to deliver therapy to patient 12, e.g., in the form of monitoring one or more patient parameters, delivery of electrical stimulation, or delivery on a therapeutic drug fluid. In one or more embodiments, the battery 26 can include a lithium-containing anode and cathode including an active material that electrochemically reacts with the lithium within an electrolyte to generate power.

Leads 18, 20, 22 that are coupled to IMD 16 can extend into the heart 14 of the patient 12 to sense electrical activity of the heart 14 and/or deliver electrical therapy to the heart. In the example shown in FIG. 1, right ventricular (RV) lead 18 extends through one or more veins (not shown), the superior vena cava (not shown), and right atrium 30, and into right ventricle 32. Left ventricular (LV) coronary sinus lead 20 extends through one or more veins, the vena cava, right atrium 30, and into the coronary sinus 34 to a region adjacent to the free wall of left ventricle 36 of heart 14. Right atrial (RA) lead 22 extends through one or more veins and the vena cava, and into the right atrium 30 of heart 14. In one or more embodiments, IMD 16 can deliver therapy to heart 14 from an extravascular tissue site in addition to or instead of delivering therapy via electrodes of intravascular leads 18, 20, 22. In the illustrated example, there are no electrodes located in left atrium 38. However, other examples can include electrodes in left atrium 38.

IMD 16 can sense electrical signals attendant to the depolarization and repolarization of heart 14 (e.g., cardiac signals) via electrodes (not shown in FIG. 1) coupled to at least one of the leads 18, 20, and 22. In some examples, IMD 16 provides pacing pulses to heart 14 based on the cardiac signals sensed within heart 14. The configurations of electrodes used by IMD 16 for sensing and pacing can be unipolar or bipolar. IMD 16 can also deliver defibrillation therapy and/or cardioversion therapy via electrodes located on at least one of the leads 18, 20, and 22. IMD 16 can detect arrhythmia of heart 14, such as fibrillation of ventricles 32 and 36, and deliver defibrillation therapy to heart 14 in the form of electrical shocks. In some examples, IMD 16 can be programmed to deliver a progression of therapies (e.g., shocks with increasing energy levels), until a fibrillation of heart 14 is stopped. IMD 16 can detect fibrillation by employing one or more fibrillation detection techniques known in the art. For example, IMD 16 can identify cardiac parameters of the cardiac signal (e.g., R-waves, and detect fibrillation based on the identified cardiac parameters).

In one or more embodiments, external device 24 can be a handheld computing device or a computer workstation. The external device 24 can include a user interface that receives input from a user. The user interface can include, for example, a keypad and a display, which can be, for example, a cathode ray tube (CRT) display, a liquid crystal display (LCD) or light emitting diode (LED) display. The keypad can take the form of an alphanumeric keypad or a reduced set of keys associated with particular functions. External device 24 can additionally or alternatively include a peripheral pointing device, such as a mouse, via which a user can interact with the user interface. In one or more embodiments, a display of external device 24 can include a touch screen display, and a user can interact with the external device via the display.

A user, such as a physician, technician, other clinician or caregiver, or the patient, can interact with external device 24 to communicate with IMD 16. For example, the user can interact with external device 24 to retrieve physiological or diagnostic information from IMD 16. A user can also interact with external device 24 to program IMD 16 (e.g., select values for operational parameters of IMD 16).

External device 24 can communicate with IMD 16 via wireless communication using any techniques known in the art. Examples of communication techniques can include, for example, low frequency or radiofrequency (RF) telemetry, but other techniques are also contemplated. In some examples, external device 24 can include a communication head that can be placed proximate to the patient's body near the IMD 16 implant site to improve the quality or security of communication between IMD 16 and external device 24.

In the embodiment depicted in FIG. 1, IMD 16 is connected (or “coupled”) to leads 18, 20, and 22. In the example, leads 18, 20, and 22 are connected to IMD 16 using the connector block 42. For example, leads 18, 20, and 22 are connected to IMD 16 using the lead connector ports in connector block 42. Once connected, leads 18, 20, and 22 are in electrical contact with the internal circuitry of IMD 16. Battery 26 can be positioned within the housing 40 of IMD 16. Housing 40 can be hermetically sealed and biologically inert. In one or more embodiments, housing 40 can be formed from a conductive material. For example, housing 40 can be formed from a material including, but not limited to, titanium, stainless steel, among others.

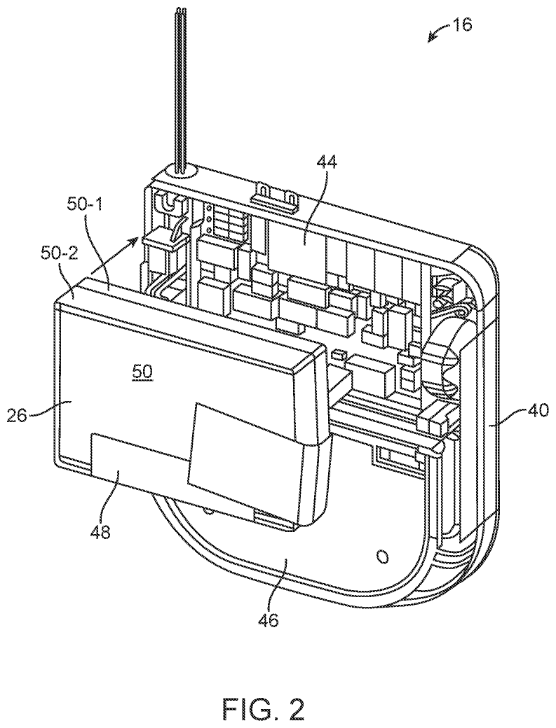

FIG. 2 is a schematic partial exploded view of the IMD 16 of FIG. 1 with connector block 42 not shown and a portion of housing 40 removed to illustrate some of the internal components within housing 40. IMD 10 includes housing 40, control circuitry 44 (which can include processing circuitry), battery 26 (e.g., an organic electrolyte battery) and capacitor(s) 46. Control circuitry 44 can be configured to control one or more sensing and/or therapy delivery processes from IMD 16 via leads 18,20, and 22 (not shown in FIG. 2). Battery 26 includes battery assembly housing 50 and insulator 48 (or liner) disposed therearound. Battery 26 charges capacitor(s) 46 and powers control circuitry 44.

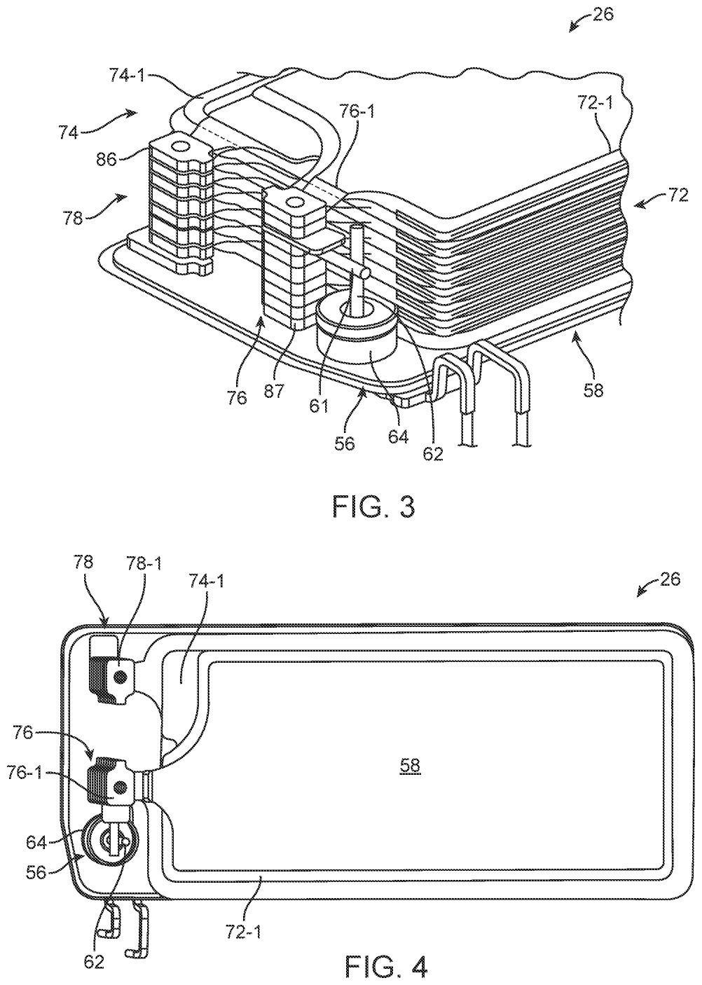

FIGS. 3-4 are various schematic views of the battery 26, which includes assembly housing 50 having a bottom housing portion 50-1 and top housing portion 50-2 (shown in FIG. 2), a feedthrough assembly 56, and an electrode assembly 58. An electrolyte can be filled into housing 50 via a fill port (not shown). The housing 50 houses electrode assembly 58 with the electrolyte. Top portion 50-2 and bottom portion 50-1 of the housing 50 can be welded or otherwise attached to seal the enclosed components of the battery 26 within the housing. Feedthrough assembly 56, which includes pin 62 as part of feedthrough 64, is electrically connected to jumper pin 61. The connection between pin 62 and jumper pin 61 allows delivery of electrical current from electrode assembly 58 to electronic components outside of the battery 26.

As mentioned herein, a fill port (not shown) allows for the introduction of liquid electrolyte to electrode assembly 58. The electrolyte creates an ionic path between anodes 72 and cathodes 74 of electrode assembly 58. The electrolyte serves as a medium for migration of ions between the anodes 72 and the cathodes 74 during an electrochemical reaction with these electrodes.

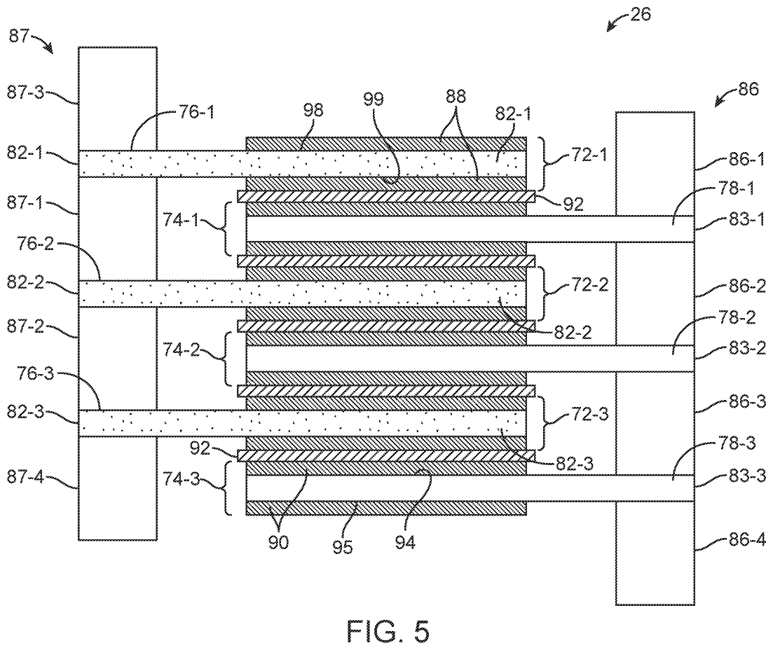

Electrode assembly or stack 58 is depicted as a stacked assembly. The assembly 58 can include a plurality of electrodes, where one or more of the electrodes are anodes 72 and one or more of the electrodes are cathodes 74. In general, each electrode includes a current collector and a tab extending from the current collector. For example, the assembly 58 can include a first electrode 72-1 and a second electrode 72-2 as shown in FIG. 5, which is a schematic cross-section view of a portion of the battery 26. For ease of description and illustration, not all tabs and spacers of electrode assembly 58 are labelled in FIG. 5; however, the description of tabs and spacers also can apply to any of the tabs and spacers described herein. Further, FIG. 5 shows anode spacers 87 disposed on an opposing side of the assembly 58 from cathode spacers 86 for illustrative purposes only. In one or more embodiments, the anode spacers 87 and the cathode spacers 86 can be disposed on the same side of the assembly 58 as is shown in FIGS. 3-4.

The first electrode 72-1 can include a first tab 76-1 extending from a current collector 82-1 of the first electrode. Further, the second electrode 72-2 can include a second tab 76-2 extending from a current collector 82-2 of the second electrode. The battery 26 can also include a spacer 87-1 disposed between the first tab 76-1 and the second tab 76-2 and electrically connected to the first and second tabs. As shown in FIG. 5, the battery 26 can include a third electrode 72-3 that includes a third tab 76-3 extending from a current collector 82-3 of the third electrode. The second tab 76-2 is disposed between the first tab 76-1 and the third tab 76-3. The spacer 87-1 can, therefore, be considered a first spacer, and the battery 26 can include a second spacer 87-2 disposed between the second tab 76-2 and the third tab 76-3. In one or more embodiments, the first electrode 72-1 can be a first anode, the second electrode 72-2 can be a second anode, and the third electrode 72-3 can be a third anode.

As illustrated, the assembly 58 also includes a first cathode 74-1 and a second cathode 74-2. The first cathode 74-1 includes a first cathode tab 78-1 that extends from cathode current collector 83-1 of first cathode. Further, the second cathode 74-2 includes a second cathode tab 78-2 extending from a cathode current collector 83-2 of the second cathode 74-2. In one or more embodiments as shown in FIGS. 3-5, the first cathode tab 78-1 and the second cathode tab 78-2 can be stacked adjacent to the first anode tab 76-1 and the second anode tab 76-2. A first cathode spacer 86-1 is disposed between the first cathode tab 78-1 and the second cathode tab 78-2, and a second cathode spacer 86-2 is disposed between the second cathode tab 78-2 and the third cathode tab 78-3.

As shown in FIGS. 3-4, the anodes 72 include one or more individual anodes such as anode 72-1 with a set of tabs 76 (including individual tab 76-1) extending therefrom that are conductively coupled via a conductive coupler (not shown). Although not labeled, the one or more spacers (e.g., anode spacers 87 of FIG. 5) can be located between respective tabs in the set of tabs 76. The conductive coupler can be a pin that extends vertically through the set of tabs 76 and spacers located between respective tabs. Additionally, or alternatively, one or more welds (not shown) can also conductively couple the set of tabs 76 and spacers. The conductive coupler can be a rivet that extends vertically through the set of tabs 76 and spacers that also mechanically attaches the individual tabs 76 and spacers to each other. Similarly, the cathodes 74 include one or more individual cathodes such as cathode 74-1 with a set of tabs 78 (including individual tab 78-1) extending therefrom that are conductively coupled via a conductive coupler (not shown). One or more spacers (e.g., cathode spacers 86 of FIG. 5) can be located between respective tabs in the set of tabs 78.

As shown in FIG. 5, the battery 26 includes one or more cathodes 74 and one or more anodes 72. In one or more embodiments, the cathodes 74 includes the first cathode 74-1, the second cathode 74-2, and the third cathode 74-3. Further, the anodes 72 include the first anode 72-1, the second anode 72-2, and the third anode 72-3. Although illustrated as including three cathodes 74 and three anodes 72, the battery 26 can include any suitable number of cathodes and anodes. Although shown as including an equal number of anodes 72 and cathodes 74, the battery 26 can include more anodes than cathodes or fewer anodes than cathodes.

Each cathode 74 includes a current collector 83 (also referred to as a cathode current collector), active material 90 disposed on the current collector, and a cathode tab 78 that extends from the current collector. The battery 26 also includes one or more cathode spacers 86 electrically connected to one or more cathode tabs 78.

Further, each anode 72 includes a current collector 82 (also referred to as an anode current collector), active material 88 disposed on the current collector, and an anode tab 76 extending from the current collector. The battery 26 further includes one or more anode spacers 87 electrically connected to one or more anode tabs 76. One or more separators 92 can be disposed between one or more adjacent cathodes 74 and anodes 72.

Each cathode 74 and anode 72 can take any suitable shape or shapes and have any suitable dimensions. In one or more embodiments, at least one cathode 74 of the electrode stack 58 can have a thickness as measured in a direction substantially orthogonal to the first portion 50-1 and second portion 50-2 of the housing 50 in a range of about 2.54 mm to about 12.7 mm. Similarly, at least one anode 72 of the electrode stack 58 can have a thickness in a range of about 2.54 mm to about 12.7 mm.

The current collector 83 of each cathode 74 can have any suitable dimensions and take any suitable shape or shapes. In one or more embodiments, the current collector 83 can be substantially planar. In one or more embodiments, the current collector 83 can be substantially curved. Further, the cathode current collector 83 can be a solid plate or a grid.

The cathode current collector 83 can have any suitable thickness as measured in a direction substantially orthogonal to a first major surface 94 or a second major surface 95 of the collector. In one or more embodiments, the cathode current collector 83 has a thickness that is in a range of about 8 μm to about 127 μm. In one or more embodiments, the cathode current collector 83 has a thickness that is in a range of about 25 μm to about 75 μm.

Further, the cathode current collector 83 can include any suitable material or materials. In one or more embodiments, the cathode current collector 83 can include at least one of titanium or copper. In one or more embodiments, the cathode current collector 83 can include a titanium alloy such as titanium grade 36 (55% titanium and 45% niobium), titanium grades 1-5, etc.

Disposed on at least one of the first major surface 94 or the second major surface 95 of the cathode current collector 83 is active material 90. In one or more embodiments, the active material 90 can be disposed on only one major surface of the cathode current collector 83 or on both major surfaces of the cathode current collector. The active material 90 can include any suitable material or materials, e.g., a material mixture including a positive electrode active material and a small amount of a binder or a conductive material. The active material 90 can include at least one of lithium-containing transition metal oxides such as lithium cobalt oxide, lithium nickel oxide, lithium manganese oxide, or carbon. The binder material can include polytetrafluoroethylene (PTFE) or rubber materials.

Extending from the cathode current collector 83 is the cathode tab 78. The cathode tab 78 can have any suitable dimensions and take any suitable shape or shapes. Further, the cathode tab 78 can include any suitable conductive material or materials, e.g., the same materials described herein regarding the cathode current collector 83. The cathode tab 78 can be connected to the cathode current collector 83 using any suitable technique or techniques, e.g., welding, bonding, mechanically fastening, etc. In one or more embodiments, the cathode tab 78 is integral with the cathode current collector 83, i.e., manufactured as one part.

Electrically connected to the cathode tab 78 is the cathode spacer 86. Although depicted as a single spacer disposed between cathode tabs 78 of the first and second cathodes 74-1, 74-2, any suitable number of spacers can be disposed between such cathode tabs. Each cathode spacer 86 can have any suitable dimensions and take any suitable shape or shapes. Exemplary spacers include a substantially H-shaped spacer, substantially rectangular spacer, circular spacer, or triangular spacer (e.g., a single triangle, a hexagon, etc.). The cathode spacers 86 can include individual thicknesses to achieve different design criteria. In one or more embodiments, a thicker cathode current collector 83 can require a thicker spacer 86. In one or more embodiments, the cathode spacer 86 can have a thickness as measured in a direction substantially orthogonal to the first major surface 94 of the cathode current collector 83 in a range of about 0.127 mm to about 5.08 mm.

The cathode spacers 86 can include any suitable material or materials. In one or more embodiments, the cathode spacers 86 include a conductive material. In one or more embodiments, the cathode spacers 86 include at least one of niobium or a niobium alloy, e.g., titanium grade 36. In one or more embodiments, the cathode spacers 86 can include a niobium alloy that includes titanium.

Similarly, the current collector 82 of each anode 72 can have any suitable dimensions and take any suitable shape or shapes, e.g., the same dimensions and shapes described herein regarding the cathode current collector 83. In one or more embodiments, the anode current collector 82 can be substantially planar. In one or more embodiments, the anode current collector 82 can be substantially curved. Further, the anode current collector 82 can be a solid plate or a grid.

The anode current collector 82 can have any suitable thickness as measured in a direction substantially orthogonal to a first major surface 98 or a second major surface 99 of the collector. In one or more embodiments, the anode current collector 82 has a thickness that is in a range of about 8 μm to about 127 μm. In one or more embodiments, the anode current collector 82 has a thickness that is in a range of about 25 μm to about 75 μm.

Further, the anode current collector 82 can include any suitable material or materials. In one or more embodiments, the anode current collector 82 can include at least one of titanium or copper. In one or more embodiments, the anode current collector 82 can include any suitable copper alloy. In one or more embodiments, the copper of the anode current collector 82 can include a laminated or bonded material with copper, or copper with electrodeposited material and nickel.

Disposed on at least one of the first major surface 98 or the second major surface 99 of the anode current collector 82 is the active material 88. In one or more embodiments, the active material 88 can be disposed on one major surface of the anode current collector 82 or on both major surfaces of the anode current collector. The active material 88 can include any suitable material or materials, e.g., a material mixture including a negative electrode active material and a small amount of a binder or a conductive material. The active material 88 can include lithium-containing transition metal oxides such as lithium cobalt oxide, lithium nickel oxide, and lithium manganese oxide. The binder material can include polytetrafluoroethylene (PTFE) or rubber materials. The anodes 72 can include the same active material 88 as the active material 90 of the cathodes 74. In one or more embodiments, the active material 88 of an anode 72 is different from the active material 90 of a cathode 74.

Extending from the anode current collector 82 is the anode tab 76. The anode tab 76 can have any suitable dimensions and take any suitable shape or shapes. Further, the anode tab 76 can include any suitable conductive material or materials, e.g., the same materials described herein regarding the anode current collector 82. The anode tab 76 can be connected to the anode current collector 82 using any suitable technique or techniques, e.g., welding, bonding, mechanically fastening, etc. In one or more embodiments, the anode tab 76 is integral with the anode current collector 82, i.e., manufactured as one part.

Electrically connected to the anode tab 76 is the anode spacer 87. Although depicted as a single spacer disposed between anode tabs 76-1, 76-2 of the first and second anodes 72-1, 72-2, any suitable number of spacers can be disposed between such anode tabs. Each anode spacer 87 can have any suitable dimensions and take any suitable shape or shapes. Exemplary spacers include a substantially H-shaped spacer, substantially rectangular spacer, circular spacer, or triangular spacer (e.g., a single triangle, a hexagon, etc.). The anode spacers 87 can include individual thicknesses to achieve different design criteria. For example, a thicker anode current collector 82 can require a thicker spacer. In one or more embodiments, the anode spacer 87 can have a thickness as measured in a direction substantially orthogonal to the first major surface 98 of the anode current collector 82 in a range of about 0.127 mm to about 5.08 mm.

The anode spacers 87 can include any suitable material or materials, e.g., the same materials described herein regarding the cathode spacers 86. In one or more embodiments, at least one anode spacer 87 includes niobium. In one or more embodiments, at least one anode spacer 87 includes the same material as at least one cathode spacer 86.

Disposed between an adjacent pair of anodes 72 and cathode 74 is the separator 92. Any suitable separator or separators 92 can be utilized with battery 26. Such separator 92 can have any suitable dimensions and take any suitable shape or shapes. As shown FIG. 3, the separator 92 can completely envelope or enclose at least one anode 72 or cathode 74. The separator 92 can be resistant to heat distortion. The separator 92 can be porous such that lithium ions can pass through the separator. The separator 92 can include a resin or other material that melts or deforms at high temperatures to close pores of the separator. According to various embodiments, pore shutdown can prevent passage of lithium ions, shutting down the battery 26 current to zero or nearly zero. In some examples, a subset of separators 92 will shut down.

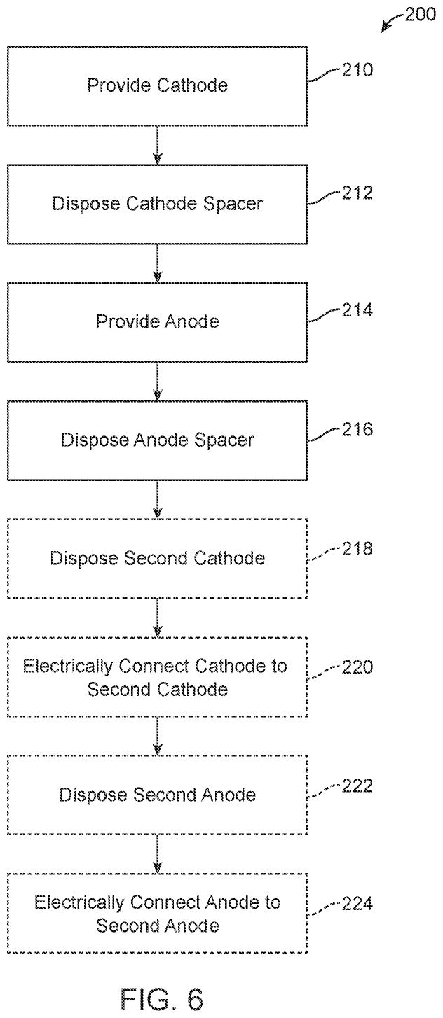

Any suitable technique or techniques can be utilized to form the battery 26. For example, FIG. 6 is a flowchart of one method 200 of forming the battery 26. Although described regarding battery 26 of FIGS. 1-5, the method 200 can be utilized to form any suitable battery. At 210, the cathode 74 can be provided using any suitable technique or techniques. In one or more embodiments, the anode 72 can first be provided. The cathode spacer 86 can be disposed in contact with the cathode tab 78 of the cathode 74 such that the cathode spacer is electrically connected to the cathode at 212. The anode 72 can be provided at 214 using any suitable technique or techniques. At 216, the anode spacer 87 can be disposed in contact with the anode tab 76 such that the anode spacer is electrically connected to the anode 72 using any suitable technique or techniques. In one or more embodiments, the second cathode 74-2 can be disposed adjacent to the anode 72 such that the anode is disposed between the cathode 74 and the second cathode at 218. In such embodiments, the cathode 74 can be considered the first cathode 74-1. Further, at 220, the cathode 74 can be electrically connected to the second cathode 74-2 utilizing the spacer 86. In one or more embodiments, the cathode tab 78-2 of the second cathode 74-2 can be disposed in contact with the spacer 86 to electrically connect the second cathode to the first cathode 74-1. In one or more embodiments, the second anode 72-2 can be disposed adjacent to the second cathode 74-2 at 222 such that the second cathode is disposed between the anode 72 and the second anode. In such embodiments, the anode 72 can be considered the first anode 72-1. At 224, the anode 72 can be electrically connected to the second node 72-2 utilizing the anode spacer 87 at 224. In one or more embodiments, the anode tab 76-2 of the second anode 72-2 can be disposed on the anode spacer 87 such that the second anode is electrically connected to the first anode 72-1.

It should be understood that various aspects disclosed herein can be combined in different combinations than the combinations specifically presented in the description and accompanying drawings. It should also be understood that, depending on the example, certain acts or events of any of the processes or methods described herein can be performed in a different sequence, can be added, merged, or left out altogether (e.g., all described acts or events cannot be necessary to carry out the techniques). In addition, while certain aspects of this disclosure are described as being performed by a single module or unit for purposes of clarity, it should be understood that the techniques of this disclosure can be performed by a combination of units or modules associated with, for example, a medical device.

In one or more examples, the described techniques can be implemented in hardware, software, firmware, or any combination thereof. If implemented in software, the functions can be stored as one or more instructions or code on a computer-readable medium and executed by a hardware-based processing unit. Computer-readable media can include computer-readable storage media, which corresponds to a tangible medium such as data storage media (e.g., RAM, ROM, EEPROM, flash memory, or any other medium that can be used to store desired program code in the form of instructions or data structures and that can be accessed by a computer).

Instructions can be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein can refer to any of the foregoing structure or any other physical structure suitable for implementation of the described techniques. Also, the techniques could be fully implemented in one or more circuits or logic elements.

What is claimed is:

1. A battery comprising:
a cathode comprising:
a current collector;
active material disposed on the current collector; and
a cathode tab extending from the current collector;
a cathode spacer electrically connected to the cathode tab;
an anode comprising:
a current collector;
active material disposed on the current collector; and
an anode tab extending from the current collector; and
an anode spacer electrically connected to the anode tab;
wherein at least one of the cathode spacer or the anode spacer comprises niobium.

2. The battery of claim 1, further comprising a separator disposed between the cathode and the anode.

3. The battery of claim 1, wherein the active material of at least one of the cathode or the anode comprises lithium.

4. The battery of claim 1, wherein the current collector of the cathode comprises a thickness in a range of about 8 μm to about 127 μm.

5. The battery of claim 1, wherein the current collector of the anode comprises a thickness in a range of about 8 μm to about 127 μm.

6. The battery of claim 1, wherein the current collector of the anode comprises copper.

7. The battery of claim 1, wherein the current collector of at least one of the anode or the cathode comprises titanium.

8. The battery of claim 1, wherein the cathode spacer comprises a thickness in a range of about 0.127 mm to about 5.08 mm.

9. The battery of claim 1, wherein the anode spacer comprises a thickness in a range of about 0.127 mm to about 5.08 mm.

10. The battery of claim 1, wherein the niobium of at least one of the cathode spacer or the anode spacer comprises a niobium alloy comprising titanium.

11. An implantable medical device comprising the battery of claim 1.

12. A battery comprising:
an electrode stack comprising a plurality of electrodes, wherein each electrode of the plurality of electrodes is either an anode or a cathode, wherein each electrode comprises a current collector comprising copper or titanium, wherein the plurality of electrodes comprises a first electrode and a second electrode, the first electrode comprising a first tab extending from the current collector of the first electrode, the second electrode comprising a second tab extending from the current collector of the second electrode; and
a spacer disposed between the first tab and the second tab and electrically connected to the first and second tabs, wherein the spacer comprises niobium.

13. The battery of claim 12, wherein the spacer comprises a first spacer, wherein the plurality of electrodes comprises a third electrode comprising a third tab extending from the current collector of the third electrode, wherein the second tab is disposed between the first tab and the third tab, the battery further comprising a second spacer disposed between the second tab and the third tab, the second spacer comprising niobium.

14. The battery of claim 12, wherein the first electrode comprises a first anode and the second electrode comprises a second anode, wherein the first tab comprises a first anode tab and the second tab comprises a second anode tab, wherein the plurality of electrodes further comprises a first cathode comprising a first cathode tab extending from the current collector of the first cathode and a second cathode comprising a second cathode tab extending from the current collector of the second cathode, wherein the first cathode tab and the second cathode tab are stacked adjacent to the first anode tab and the second anode tab.

15. The battery of claim 14, wherein the spacer comprises an anode spacer disposed between the first anode tab and the second anode tab, wherein the battery further comprises a cathode spacer disposed between the first cathode tab and the second cathode tab.

16. The battery of claim 14, wherein the current collector of each of the first and second anodes comprises copper.

17. The battery of claim 14, wherein the current collector of each of the first and second cathodes comprises titanium.

18. The battery of claim 12, further comprising active material disposed on the current collector of each of the first and second electrodes.

19. The battery of claim 12, further comprising a separator disposed between the first electrode and the second electrode.

20. A method for forming a battery comprising:
providing a cathode comprising a current collector, a cathode tab extending from the current collector, and active material disposed on the current collector;
disposing a cathode spacer in contact with the cathode tab such that the cathode spacer is electrically connected to the cathode;
providing an anode comprising a current collector, an anode tab extending from the current collector, and active material disposed on the current collector; and
disposing an anode spacer in contact with the anode tab such that the anode spacer is electrically connected to the anode;
wherein at least one of the cathode spacer or the anode spacer comprises niobium.
